(19) United States
(12) Patent Application Publication
(10) Pub. No.: US 2004/0044518 A1
(43) Pub. Date: Mar. 4, 2004

(54) Method and system for multilingual display generation

(76) Inventors: John E. Reed JR., Coon Rapids, MN (US); Anne M. Steiner, Roseville, MN (US)

Correspondence Address: Charles A. Johnson, Unisys Corporation, Attorney for Applicants, P O Box 64942 MS 4773, St. Paul, MN, 55164, US

(21) Appl. No.: 10/228,566

(22) Filed: Aug. 27, 2002

(51) Int. Cl. G06F 17/20; G09G 5/00

(52) U.S. Cl. 704/8; 345/744

(57) ABSTRACT

Methods and systems are provided for generating a multilingual web page by execution of a web application providing access to web page expressions in multiple languages. Alternative translations for the web page expressions are identified and associated with labels. The alternative translations and associated labels are grouped into one or more libraries. According to one aspect of the invention, a language-specific library file including alternative translation values of web page expressions is identified corresponding to the language of the web page. In accordance with another aspect of the invention, a composite library file is used, the composite library including all alternative translations values for the web page expressions. Alternative translations for the web page expressions are accessed from library files using the associated labels. A multilingual web page is generated using the alternative translations for the expressions.

### FIELD OF THE INVENTION

The present invention generally relates to generating a display, and more particularly to generating a multilingual web page display.

### BACKGROUND OF THE INVENTION

The internet provides access to a vast array of services and information resources. For many users, connection to the internet is an essential tool, providing a link to documents, pictures or videos downloaded from a computer located within the same city, or from a computer located on the other side of the world. Users may access informational resources and e-commerce opportunities through the internet by linking to web pages available via the World Wide Web (WWW).

Global organizations and e-commerce businesses seek to connect with people across the world through their web sites. According to recent estimates, approximately 40% of the online population is English speaking. Native speakers of Chinese, Japanese, Spanish, German, Korean, French, Italian, Portuguese, and Dutch comprise the majority of the remaining 60% of the online population. Multilingual web pages provide a way for international organizations to easily connect with people who speak a variety of languages.

The files used for generating web pages are typically written in Hypertext Markup Language (HTML), including code indicating how a web page should be displayed by a browser application running on the user's computer. Programming languages such as Java, JavaScript, and Visual Basic may be used to extend the capabilities of a web page. Scripting languages, such as JavaScript, enable web page authors to design dynamic, interactive web sites. Small programs written in JavaScript maybe embedded within an HTML web page file, or called externally by the web page application, to enhance the functionality of the web page.

Typically, HTML web page files are coded for specific written languages and each web page in a particular language requires a separate HTML file. A separate web page file must be written and maintained for each language translation. The increasing number of languages used by people online makes this task increasingly cumbersome. Methods and systems that address the problems of creating multilingual web pages, as well as other related problems, are therefore desirable.

### SUMMARY OF THE INVENTION

In various embodiments, the invention provides a method and apparatus for displaying expressions using language-independent source code and one or more library files including translations of the expressions.

In accordance with another embodiment of the invention, a method for communicating expressions on a web page in a number of languages involves associating alternative translation values for expressions displayed on a web page with labels. The labels and associated alternative translation values are organized into one or more library files. A language for the web page is selected. The language is associated with a particular library file. A web page information fileset is downloaded from a server to a workstation that includes the particular library file associated with the selected language. Alternative translation values are for the expressions on the web page are obtained by accessing the library file using the labels. The web page is generated on the workstation display using the alternative translation values.

A further embodiment of the invention involves a system for displaying expressions on a web page. The system includes a server configured to download a web page information fileset. The web page information fileset includes an application file for generating outputs to produce a web page display and a library file. Alternative translation values for web page expressions labels associated with the alternative translation values are included in the library file. A workstation coupled to the server is configured to receive the web page information fileset. The workstation interprets the application file to produce the web page display and accesses the alternative translation values for expressions displayed on the web page using the labels. A display coupled to the workstation is configured to display the expressions represented by alternative translation values.

In yet another embodiment of the invention, a system for generating expressions on a display includes means for associating alternative translation values for the expressions with labels, means for organizing the labels and the associated alternative translation values into one or more library files, means for selecting a language for the expressions, the language associated with a particular library file, means for obtaining alternative translation values for the expressions by accessing a particular library file using the labels, and means for generating the expressions on the display using the alternative translation values.

In a further embodiment of the invention, a system for generating a web page display on a workstation includes means for associating alternative translation values for expressions displayed on the web page with labels, means for organizing the labels and the associated alternative translation values into one or more library files, means for selecting a language for the web page, the selected language associated with a particular library file, means for downloading a web page information fileset from a server to the workstation, the web page information fileset including the particular library file corresponding to the selected language, means for obtaining alternative translation values for the expressions by accessing the particular library file using the labels, and means for generating the web page on the workstation using the obtained alternative translation values for the expressions.

Another embodiment of the invention involves a computer-readable medium configured with executable instructions for causing one or more computers to perform a method of communicating expressions on a web page in a plurality of languages. The method includes associating alternative translation values for expressions displayed on the web page with labels, organizing the labels and the associated alternative translation values into one or more library files, selecting a language for the web page, the selected language associated with a particular library file, downloading a web page information fileset from a server to the workstation display, the web page information fileset including the particular library file corresponding to the selected language, obtaining alternative translation values for the expressions by accessing the particular library file using the labels, and generating the web page on the workstation display using the obtained alternative translation values for the expressions.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a flowchart illustrating a method for generating expressions on a workstation display in accordance with an embodiment of the invention;

FIG. 2 is a flowchart illustrating a method for generating a web page in accordance with an embodiment of the invention;

FIG. 3 is a block diagram illustrating a conceptual architecture of system for generating a display including language library files in accordance with an embodiment of the invention;

FIG. 4 is a data flow diagram illustrating interaction between a browser and server for producing a multilingual web page in accordance with an embodiment of the invention;

FIG. 5 is a flowchart illustrating a method for generating a multilingual web page display using multiple language-specific library files in accordance with an embodiment of the invention; and

FIG. 6 is a flowchart illustrating a method for generating a multilingual web page display using a composite language library in accordance with an embodiment of the invention.

### DETAILED DESCRIPTION

Generally, the present invention provides a system and method for generating a display including translations of the expressions displayed into multiple languages. The invention is believed to be particularly beneficial for developing, operating, and maintaining multilingual computer-based web page displays suitable for global access.

Presently, computer-based displays, such as web pages, are coded for specific languages. Each display file for a particular language is maintained separately. If a translation of the web page is desired, the display file is re-coded in the new language. Re-coding the web page file requires a complete duplication of the HTML source code for each supported language. Further, the translation must be performed by a person proficient in HTML, as well as other programming languages used to generate the web page application.

In various embodiments, the present invention provides systems and methods for creating a computer-generated display offering a number of translations for expressions presented on the display without the need for separate files to support each translation. Various translations can be added, removed, and changed without the need to re-compile, re-generate or re-install the display application's source code.

The expressions presented on a computer-generated display may have various forms, including text, graphic symbols or audio sequences, for example. The term “language” is used herein to represent any group of associated expressions conforming to a particular system for communicating. For example, in accordance with the present invention, English text expressions may be associated with a first language. Audio sequences of spoken English may be associated with a second language. Expressions from the first language, English text, may be translated into equivalent expressions in the second language, audio sequences of spoken English, using the methods of the present invention. Similarly, text or audio expressions may be translated into another language, for example, a language using graphic symbols.

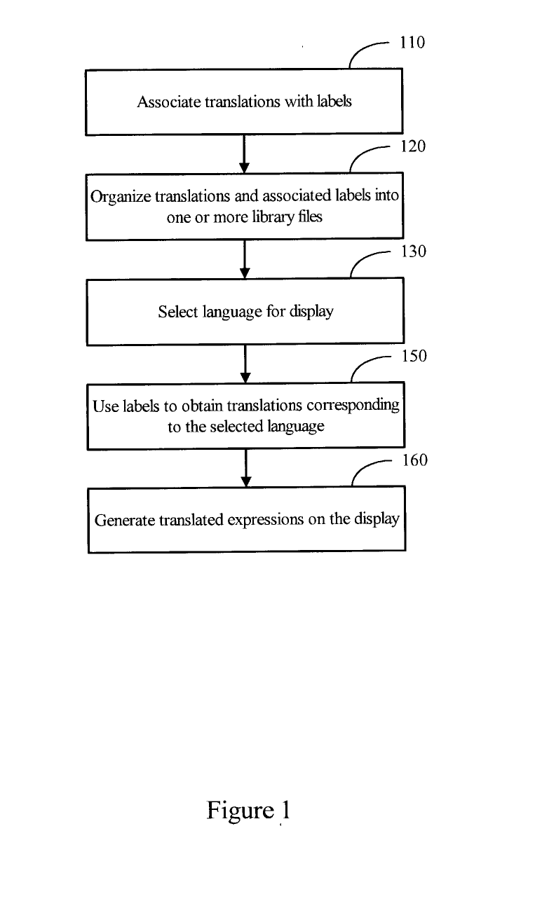

FIG. 1 is a flowchart illustrating a method for generating translated expressions on a display in accordance with an embodiment of the invention. Alternative language translations of an expression are associated 110 with labels and organized 120 into one or more library files. A language is selected 130 for generating expressions on the display. Translations corresponding to the selected language are obtained 150 from the one or more library files using the labels. Translated expressions are generated 160 on the display.

The present invention is particularly advantageous when used to create computer-based web page displays suitable for access by users worldwide. A web page display file is typically accessed by the workstation from a web page server. The web page display file is downloaded, interpreted by a workstation browser, and displayed on the workstation monitor. The web page may include various expressions conveying information to the web page viewer. By the methods of the present invention, the web page expressions may be translated into one or more alternative translations.

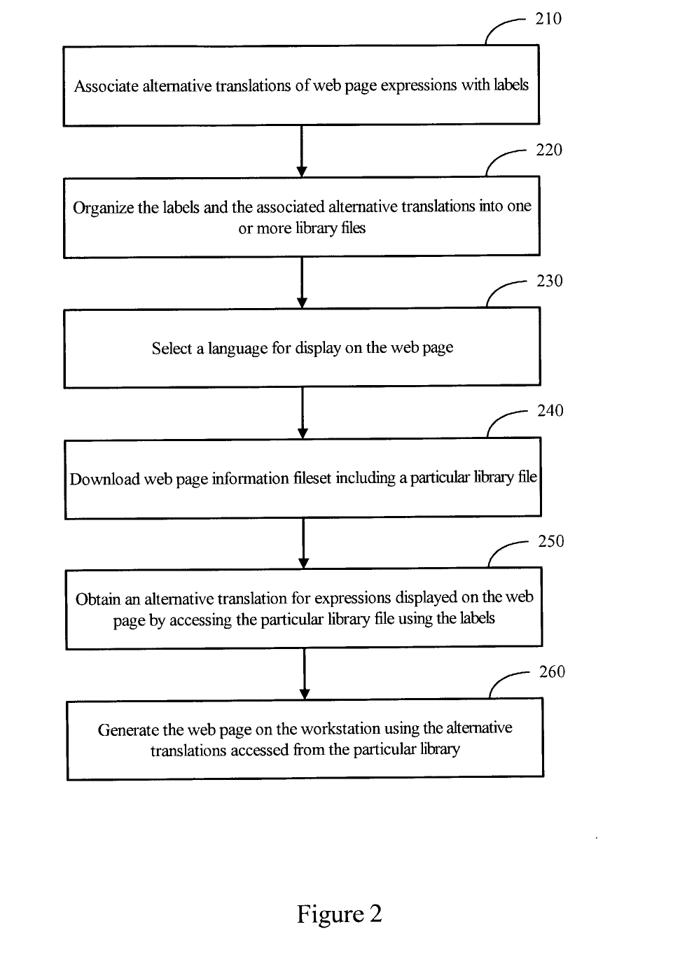

FIG. 2 is a flowchart illustrating a method for generating a web page on a workstation in accordance with an embodiment of the invention. Alternative translations of the web page expressions are associated 210 with labels. The labels and their associated alternative translations are organized 220 into one or more library files. The labels act as pointers to the alternate language translations in the one or more library files. A language associated with a particular language file is selected 230 for the web page. A web page display information fileset, including a web page application file and a particular library file is downloaded 240 from the web page server to the workstation. Alternative translations for web page expressions are obtained 250 by accessing the particular library file using the labels. The web page is generated 260 on the workstation display using the alternative translations obtained for the expressions.

In accordance with one specific embodiment of the present invention, a multilingual HTML web page is generated by providing alternate translations for text-based expressions displayed on the web page. The text-based expressions are represented in code by literal strings. Each literal string representing a translation of a text-based expression may be associated with a JavaScript label. The literal strings and their associated JavaScript labels are grouped into one or more language files. For example, one language file may include web page expressions represented as literal strings in English, one language file includes web page expressions represented as literal strings in Spanish, etc. Alternatively, a composite language file may include expressions in both English and Spanish. The JavaScript labels are used as pointers to alternative translations of the web page expressions in the language files.

Selection of a particular language for the web page identifies the corresponding language file used to generate the web page. The language file includes literal strings representing web page expressions translated into the particular language of the web page. Each web page expression in the library file is associated with a JavaScript label. JavaScript code, used to generate the HTML web page, references the labels to access the literal strings used to generate the expressions on the web page display. Consequently, while the label always remains the same, the literal string pointed to by the label will vary according to the language file selected. The expressions displayed on the web page are generated using the literal strings obtained from the language file by referencing the labels associated with the literal strings.

By way of example, consider the following JavaScript code used to produce a simple web page:

//Function to create a web page
function loadScreen()
{

document.write()
“<html>\n”
“<head>/n”
“<title>This Is the Screen Title</title>\n”
“</head>\n”
“<body>\n”
. . .
“<body>\n”
“<html>\n”);

}

Between the <title>tags, there is the literal string “This is the Screen Title.” When the above function is executed, the text “This is the Screen Title” is displayed in the Internet browser's title bar. A typical web page may include many such expressions. Translation of the web page expressions from one language to another typically requires translation of each expression embedded in the code.

The present invention allows multilingual web pages to be generated without requiring re-coding for each language translation. Continuing with the above example, in accordance with the principles of the present invention, the literal string “This is the Screen Title” in the function above is removed and is replaced by a label pointing to the literal string. Thus, the JavaScript function no longer includes an embedded English expression. The JavaScript function for generating the web page may now be written:

//Function to create a web page
function loadScreen()
{

document.write()
“<html>\n”
“<head>/n”
“<title>“ + screen_title + “</title>\n”
“</head>\n”
“<body>\n”
. . .
“<body>\n”
“<html>\n”);

}

The literal string “This is the Screen Title” has been replaced by the label screen_title in the above JavaScript function. The label screen_title is used to point to literal strings representing translations of the original English literal string “This is the Screen Title” into various languages. The English-language literal string is no longer present in the source code. The label replacing the literal string may be used to access the English-language literal string or translations of the English-language literal string as desired.

Although the above example only contemplates text-based translations, one skilled in the art will recognize that the present invention is not limited to text-based applications. The methods of the present invention may be used in an analogous manner for providing web page translations between text, audio or graphic symbols, for example. More generally, the methods of the present invention may be used to provide translations between groups of expressions, where each group of expressions conforms to a particular system for communicating.

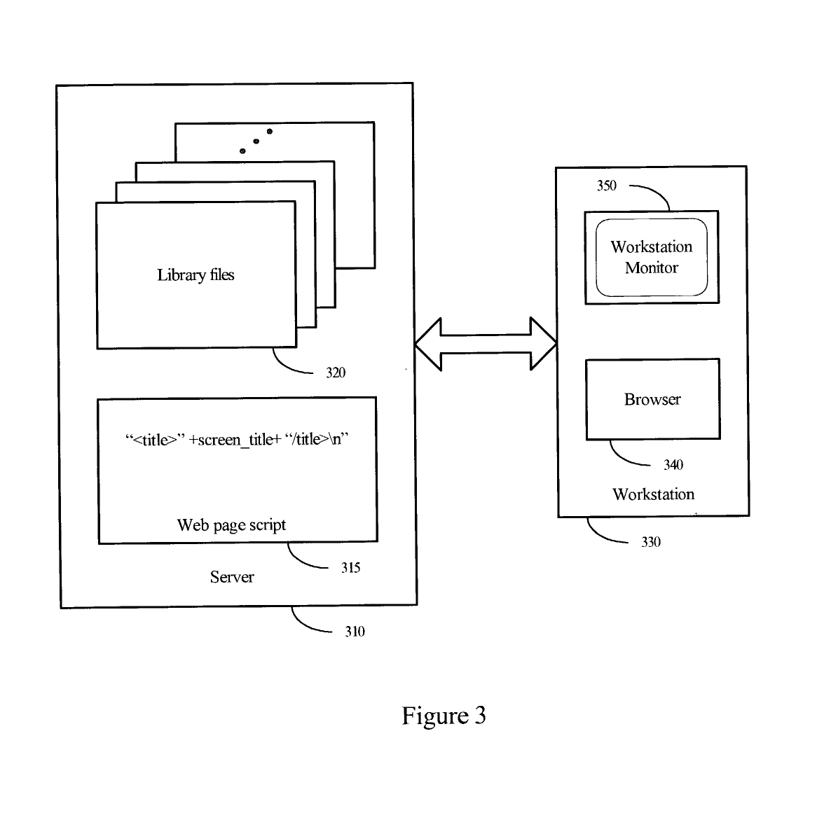

An example of a conceptual architecture for implementing the present invention is illustrated in FIG. 3. A web page script file 315 stored on a web page server 310 is used to generate an HTML web page on a workstation 330. Also stored on the server 310 are one or more library files 320 incorporating translations of expressions used for the web page. The web page server 310 may be coupled to a workstation 330, for example, though the internet. A browser application 340 running on the workstation 330 interprets an HTML web page file downloaded from the server 310 and generates the web page display on the workstation monitor 350.

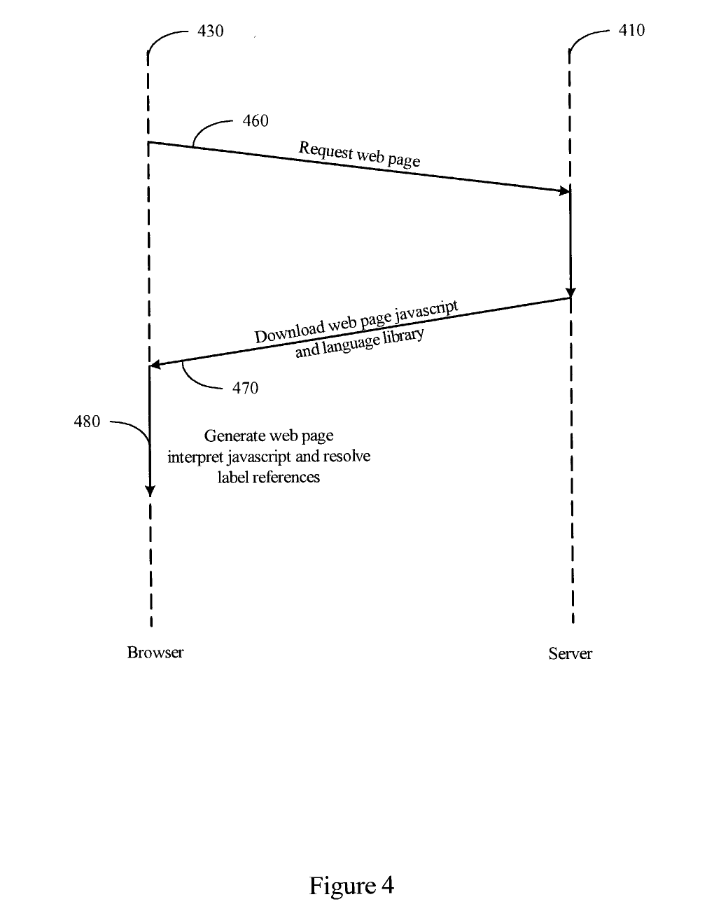

FIG. 4 is a data flow diagram illustrating the communications flow between a web page server 410 and workstation 430 for generating a web page in accordance with an embodiment of the present invention. The workstation 430 requests 460 a web page file from the web page server 410. The web page server 410 downloads 470 the web page file, for example, a JavaScript application file and a library file, to the workstation 430. A browser application running on the workstation 430 interprets the JavaScript, accesses the library file to resolve the label references, and generates 480 the web page display in the appropriate language.

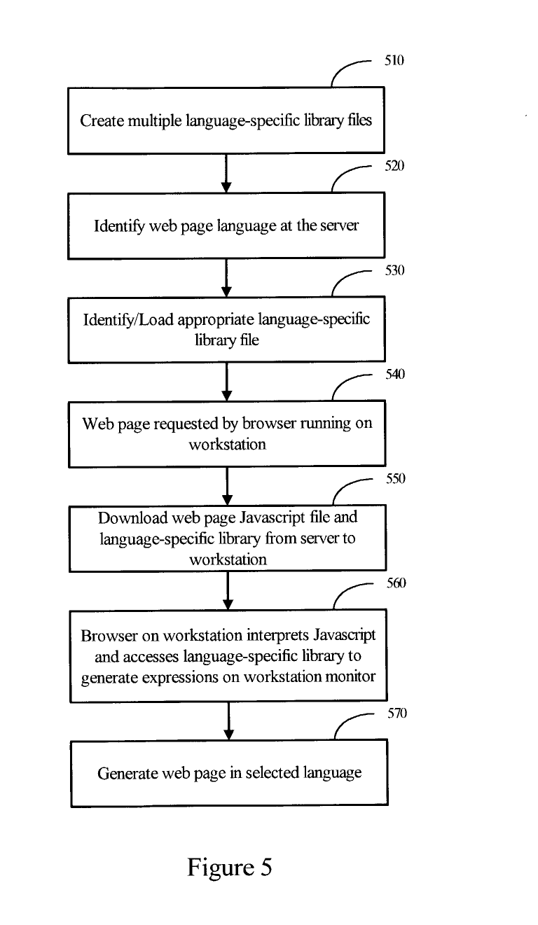

In accordance with an example implementation of the present invention, a number of language-specific library files are stored on the web page server along with a JavaScript application for generating the web page HTML file. In this example implementation, illustrated in the flowchart of FIG. 5, a language-specific library file is created 510 for each desired language translation of the web page. The language of the web page is identified 520 at the server. Identification of the web page language correspondingly identifies the language-specific library file used for generating the web page. The appropriate language-specific library file is loaded 530 on the server. Alternatively, multiple language-specific library files may be stored on the server and the appropriate language-specific library file activated when the web page language associated with the language-specific library file is selected.

The web page display file is requested 540 by a workstation browser. In response to the request by the browser, the server downloads 550 the web page JavaScript file and the identified language-specific library file to the workstation. The browser application running on the workstation interprets 560 the JavaScript file, accessing the language-specific library file to obtain appropriate translations of the web page expressions. The web page is generated 570 in the selected language.

In another example implementation of the invention, a composite language library file may be created incorporating a number of language translations for web page expressions into a single file. According to this embodiment, the composite language library file may be downloaded to the workstation from the web page server and used to generate the web page based on a language selection made at the workstation. For example, the language selection may be made by the user selecting a language displayed in a drop down menu. Information about the language selection may be stored in a cookie resident on the workstation. The cookie may be used for subsequent accesses to the web page to provide the web page in the selected language.

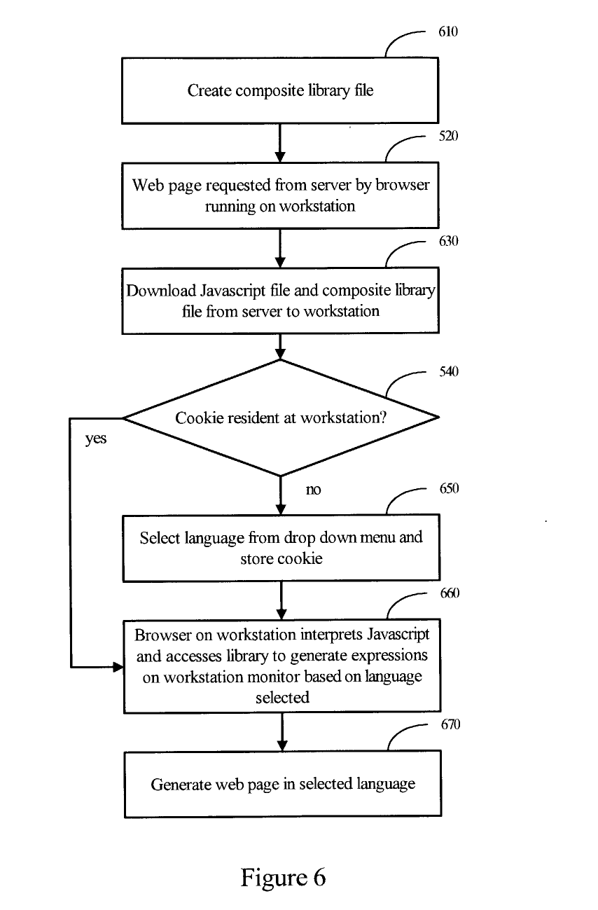

The flowchart of FIG. 6 illustrates a method for multilingual web page generation using a composite library file. The composite language library file for the web page is created and stored 610 at the server. The web page display file is requested 620 by a workstation browser. In response to the request by the browser, the server downloads 630 the web page display file to the workstation, including the JavaScript application file and the composite language library file.

If a cookie is resident on the workstation 640, indicating the language selection for the web page, the web page is generated in the language identified by the cookie. If a cookie is not resident 640, the web page language may be selected 650 at the workstation, for example, by using a drop-down menu, and a cookie is stored indicating the language selection. To facilitate the selection of a language, the HTML code incorporates a function for producing the drop-down menu box and storing a cookie based on the selection from the drop-down box. The browser on the workstation interprets 660 the web page JavaScript application and accesses alternative translation values from the composite library based on the language selected. The web page is generated on the workstation display 670 in the selected language. Subsequent accesses to the web page generate a web page display using the language indicated by the stored cookie.

By way of example, a composite language library file may include literal string values representing translations of text expressions for each language supported by the web page. A sample composite language library file for providing translations of the expression “This is the Screen Title” is provided in the following sample code:

//Sample library file
//Get language value from the cookie
language = GetCookie(‘language’);
//Literal string label Associated value - actual text to appear on the

web page

if (language == ‘english’)
{

var screen_title = “This is the Screen Title”;

}
else if (language == ‘spanish’)
{

var screen_title = “Éste es el titulo de Ia imagen”;

}
else if (language == ‘german’)
{

var screen_title - “Das ist eine bildscirm title”;

}

Code within the library file retrieves a language variable from the cookie stored on the workstation identifying the selected language. The web page is displayed in the selected language based on a language variable stored in the cookie. Thus, no changes are required to the JavaScript code generating the web page.

The translated expression is accessed using the label associated with the expression. Various language cases are tested until the language case tested matches the language variable retrieved from the cookie. The web page expression is displayed in the selected language.

In accordance with the methods of the invention, a single web application can provide access to multiple languages for generating web page expressions. In addition to translating the literal strings as in the examples above, web page expressions may be translated into any alternative expressions conforming to a particular system for communicating. For example, using the principles of the present invention, literal strings may be represented as audio sequences or graphic symbols.

The present invention provides a number of advantages over previous methods. For example, previous methods required source code re-compilation for each translation of a web page. In addition, by previous methods, it was necessary to create and maintain the application source code in each supported language. The present invention allows a single source code to support multiple languages. Further, the language of the web page may be changed at any time by swapping language-specific library files, or using a composite language library and making a language selection at a workstation. The source code of the present invention is language independent, and changes to the web page language only affect the language library.

Additional advantages may be attained when implementing the methods of the present invention to provide translations of text expressions for a web page. The language library may be configured to be simple enough to allow easy editing of the language library file by individuals who are not web programmers. Thus, it is unnecessary for the person translating the literal strings to be fluent in HTML or JavaScript, for example.

Furthermore, using a composite language library in accordance with methods of the present invention provides additional advantages. Using a composite language library, support for multiple languages can exist at once on a single web page. When multiple language translations are maintained in a composite language library, each client workstation can display the web page in a different language. The language may be changed at any time at the workstation by selecting a different language, without reloading the web page from the server. In addition, the use of a composite language library reduces the need to swap language-specific library files to change the web page language.

A method for communicating expressions on a web page in a plurality of languages in accordance with the present invention may be tangibly embodied in a computer-readable medium or carrier, e.g. one or more of the fixed and/or removable data storage devices, or other data storage or data communications devices. One or more computer programs expressing the processes embodied on the removable data storage devices may be loaded into various memory elements located within a system for communicating multilingual expressions on a web page to configure the multilingual communication system for operation in accordance with the invention. The computer programs comprise instructions which, when read and executed by the multilingual communication system, cause the multilingual communication system to perform the steps necessary to execute processes for involving communicating multilingual expressions on a web page.

The processes for communicating multilingual expressions on a web page in accordance with the principles of the present invention include associating alternative translation values for expressions displayed on the web page with labels, organizing the labels and the associated alternative translation values into one or more library files, selecting a language for the web page, the selected language associated with a particular library file, downloading a web page information fileset from a server to the workstation display, the display information file including the particular library file corresponding to the selected language, obtaining alternative translation values for the expressions by accessing the particular library file using the labels, and generating the web page on the workstation display using the obtained alternative translation values for the expressions.

Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for communicating expressions on a web page in a plurality of languages, comprising:
associating alternative translation values for expressions displayed on the web page with labels;
organizing the labels and the associated alternative translation values into one or more library files;
selecting a language for the web page, the selected language associated with a particular library file;
downloading a web page information fileset from a server to the workstation display, the web page information fileset including the particular library file corresponding to the selected language;
obtaining alternative translation values for the expressions by accessing the particular library file using the labels; and
generating the web page on the workstation display using the obtained alternative translation values for the expressions.

2. The method of claim 1, wherein associating the alternative translation values for the expressions with the labels comprises associating alternative graphic symbols for the expressions with the labels.

3. The method of claim 1, wherein associating the alternative translation values for the expressions with the labels comprises associating alternative audio translation values for the expressions with the labels.

4. The method of claim 1, wherein associating the alternative translation values for the expressions with the labels comprises associating alternative language-specific character strings for the expressions with the labels.

5. The method of claim 1, wherein associating the alternative translation values for the expressions with the labels comprises associating alternative combinations of graphic symbols, language-specific character strings, and audio translation values for the expressions with the labels.

6. The method of claim 1, wherein organizing the labels and the associated alternative translation values into one or more library files comprises organizing the labels and the associated alternative translation values into a plurality of language-specific library files.

7. The method of claim 6, wherein selecting the language for the expressions further comprises identifying a language-specific library file as the particular library file.

8. The method of claim 1, wherein organizing the labels and the associated alternative translation values into one or more library files comprises organizing the labels and the associated alternative translation values into a single composite library file.

9. The method of claim 8, where selecting the language for the expressions further comprises identifying the composite library file as the particular library file.

10. The method of claim 1, wherein selecting the language for the web page comprises selecting the language at the server; and
downloading the web page information fileset comprises downloading the web page information fileset including a language-specific library file corresponding to the selected language.

11. The method of claim 1, wherein downloading the web page information fileset comprises downloading the web page information fileset including a composite language library file; and
selecting the language for the web page comprises selecting the language at the workstation.

12. The method of claim 11, further comprising:
storing information identifying the selected language on the workstation; and
using the stored information to access the alternative translation values for expressions displayed on the web page.

13. A system for communicating expressions in a plurality of languages, comprising:
a server configured to download a web page information fileset, the web page information fileset comprising an application file for generating outputs to produce a web page display, and further including a library file that includes alternative translations values for expressions displayed on the web page and labels associated with the alternative translation values;
a workstation coupled to the server and configured to receive the web page information fileset and interpret the application file to produce the web page display, the application file accessing the alternative translation values for expressions displayed on the web page from the library file using the labels; and
a workstation display configured to output the expressions using the alternative translation values.

14. The system of claim 13, wherein the alternative translation values comprise character strings.

15. The system of claim 13, wherein the alternative translation values comprise graphic symbols.

16. The system of claim 13, wherein the alternative translation values comprise audio sequences.

17. The system of claim 13, wherein the alternative translation values comprise combinations of character strings, graphic symbols and audio sequences.

18. The system of claim 13, wherein the library file comprises a language-specific file.

19. The system of claim 13, wherein the library file comprises a composite library file including all the alternative translation values for each expression displayed on the web page and the associated labels.

20. The system of claim 13, wherein the application file comprises a JavaScript application, the JavaScript application interpreted at the workstation to produce an HTML web page.

21. A multilingual communication system, comprising:
means for associating alternative translation values for expressions displayed on the web page with labels;
means for organizing the labels and the associated alternative translation values into one or more library files;
means for selecting a language for the web page, the selected language associated with a particular library file;
means for downloading a web page information fileset from a server to the workstation, the web page information fileset including the particular library file corresponding to the selected language;
means for obtaining alternative translation values for the expressions by accessing the particular library file using the labels; and
means for generating the web page on the workstation using the obtained alternative translation values for the expressions.

22. A computer-readable medium configured with executable instructions for causing one or more computers to perform a method of communicating expressions on a web page in a plurality of languages, the method comprising:
associating alternative translation values for expressions displayed on the web page with labels;
organizing the labels and the associated alternative translation values into one or more library files;
selecting a language for the web page, the selected language associated with a particular library file;
downloading a web page information fileset from a server to the workstation display, the web page information fileset including the particular library file corresponding to the selected language;
obtaining alternative translation values for the expressions by accessing the particular library file using the labels; and
generating the web page on the workstation display using the obtained alternative translation values for the expressions.
